(19) United States
(12) Patent Application Publication
(10) Pub. No.: US 2004/0180194 A1
(43) Pub. Date: Sep. 16, 2004

(54) Fish tape with rolling end

(76) Inventor: Isaac D. White, Orlando, FL (US)

Correspondence Address: KIRKPATRICK & LOCKHART LLP, 535 SMITHFIELD STREET, PITTSBURGH, PA, 15222, US

(21) Appl. No.: 10/387,022

(22) Filed: Mar. 12, 2003

(51) Int. Cl. B32B 7/12

(52) U.S. Cl. 428/343; 428/354

(57) ABSTRACT

A fish tape comprising a spherical portion disposed in a cutout portion of an end of the fish tape, wherein the spherical portion is attached to the end of the fish tape.

### BACKGROUND

The present invention is directed generally and in various embodiments to a fish tape having a rolling end.

Fish tape is often used to fish wires and cable through an area that may not be accessible (e.g. a wall) or through conduit piping. FIG. 1 is a diagram illustrating an example of a prior art fish tape device 10. An end 11 of a fish tape 12 extends from a reel assembly 14. The fish tape 12 is wound inside the assembly 14. The fish tape 12 may be constructed of a durable material such as, for example, steel tape or steel wire. The assembly 14 may include a handle 16 that is used to hold the device 10 in operation and to transport the device 10. The assembly 14 may also include a hand-operated crank or motor-operated device (not shown) that is used to retract the fish tape 12 into the assembly 14. The end 11 of the fish tape 12 terminates with an end device 18. The end device, 18 may be, for example, a slotted device that is formed or attached to the fish tape 12 or may be a bend or series of bends formed in the fish tape 12.

In operation, a user of the device 10 extends the fish tape 12 into a cavity or a conduit until a desired termination point is reached. A wire or cable is then tied, taped, or attached to the end device 18 and the user retracts the fish tape 12 into the assembly 14, thus drawing the wire or cable through the cavity or conduit.

Various other types of fish tape devices exist that are shaped differently than the fish tape device 10 or that do not include the assembly 14 but instead include a fish tape that is coiled without retracting into an assembly. Various embodiments of the present invention are intended to function regardless of the type of fish tape device on which the embodiments of the invention are employed.

### SUMMARY

In one embodiment, the present invention is directed to a fish tape. The fish tape includes a spherical portion disposed in a cutout portion of an end of the fish tape, wherein the spherical portion is attached to the end of the fish tape.

In one embodiment, the present invention is directed to a fish tape. The fish tape includes a wheel disposed in a cutout portion of an end of the fish tape, wherein the wheel is attached to the end of the fish tape.

In one embodiment, the present invention is directed to a fish tape. The fish tape includes a roller assembly attached to an end of the fish tape and a spherical portion disposed in the roller assembly.

### BRIEF DESCRIPTION OF THE DRAWINGS

Further advantages of the present invention may be better understood by referring to the following description taken in conjunction with the accompanying drawings, in which:

FIG. 1 is a diagram illustrating an example of a prior art fish tape device;

FIG. 2 is a diagram illustrating a side view of an end of a fish tape according to one embodiment of the present invention;

FIG. 3 is a diagram illustrating a top view of the end of the fish tape of FIG. 2 according to one embodiment of the present invention;

FIG. 4 is a diagram illustrating a top view of an end of a fish tape according to one embodiment of the present invention;

FIG. 5 is a diagram illustrating a side view of an end of a fish tape according to one embodiment of the present invention; and

FIG. 6 is a diagram illustrating a top view of the end of the fish tape of FIG. 5 according to one embodiment of the present invention.

### DESCRIPTION

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein.

FIG. 2 is a diagram illustrating a side view of an end 20 of a fish tape 22 according to one embodiment of the present invention. A spherical portion 24 is disposed in a cutout portion 25 of the fish tape 22 (see FIG. 3). The spherical portion 24 is attached to the fish tape 22 by way of a spindle, or axle, 26. The spherical portion 24 may be, for example, a sphere constructed of a material that has high durability and low rolling resistance such as, for example, steel, stainless steel, or plastic. Similarly, the spindle 26 may be constructed of a material such as, for example, steel, stainless steel, or plastic.

FIG. 3 is a diagram illustrating a top view of the end 20 of the fish tape 22 of FIG. 2 according to one embodiment of the present invention. As illustrated in FIG. 3, the spindle 26 may be attached to the fish tape 22 by any conventional method such as, for example, by fabricating ends 28 to be larger than the holes in the fish tape 22 in which the spindle 26 is disposed. Legs 29 may be fabricated as an integral part of the fish tape 22 or may be attached to the fish tape 22 by, for example, a weld or a fastener.

The spindle 26 may pass through an opening in the spherical portion 24 such that the spherical portion 24 may rotate as it contacts a surface. In another embodiment, the spherical portion 24 is fixedly attached to the spindle 26 such that the spherical portion 24 does not rotate. In another embodiment, the spherical portion 24 is fixedly attached to the fish tape 22 by, for example, a fastener or by a molding process, thus eliminating the need for the spindle 26.

As illustrated in FIGS. 2 and 3, the spindle 26 passes through a portion of the fish tape 22. However, it can be understood that various arrangements may used in which the spindle is attached to arms that are in turn attached to the fish tape 22. Also, in various embodiments, the spherical portion 24 may have multiple degrees of freedom of rotation and movement. For example, the slots in which the spindle 28 are disposed may be enlarged such that the spindle 26 is secured in the slots but the spindle 26 and the spherical portion 24 can move laterally, horizontally, or in any direction as permitted by the shape of the slots.

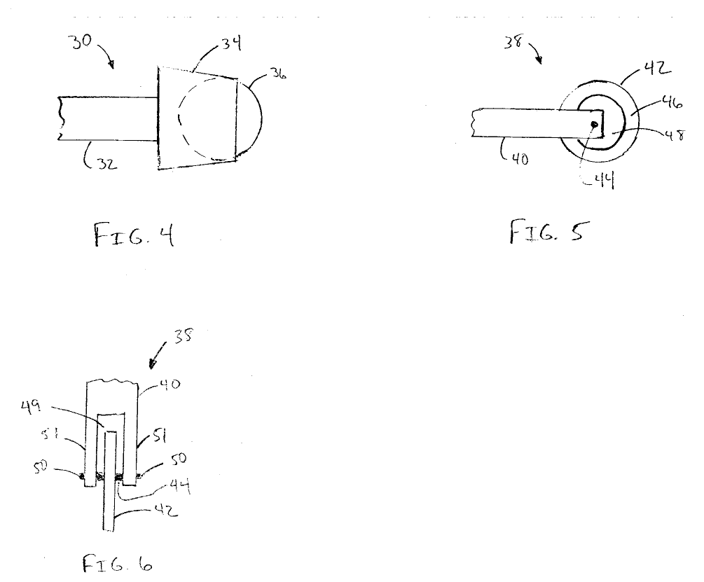

FIG. 4 is a diagram illustrating a top view of an end 30 of a fish tape 32 according to one embodiment of the present invention. The end 30 includes a roller assembly 34 in which a spherical portion 36 is disposed. The assembly 34 may be attached to the fish tape 32, may be molded onto the fish tape 32, or may be fabricated as an integral portion of the fish tape 32. The assembly 34 may be constructed of any suitable material such as, for example, plastic or steel. The spherical portion 36 may be, for example, a sphere constructed of a material that has high durability and low rolling resistance such as, for example, steel, stainless steel, or plastic. Although the assembly 34 is illustrated in FIG. 4 as having a tapered shape, it can be understood that the assembly 34 may be any suitable shape such that the spherical portion 36 is retained in the assembly 34. The assembly 34 may be sized such that the spherical portion 36 is able to rotate or such that the spherical portion is fixedly retained in the assembly.

FIG. 5 is a diagram illustrating a side view of an end 38 of a fish tape 40 according to one embodiment of the present invention. A wheel 42 is attached to the fish tape 40 via an axle 44. The wheel 42 may be constructed of any suitable material such as, for example, plastic, steel, or rubber. In one embodiment, a contact portion 46 of the wheel 42 is constructed of a different material than a hub portion 48 of the wheel 42. In one embodiment, the axle 44 is constructed of any suitable material that permits the wheel 42 to rotate such as, for example, steel or plastic. In another embodiment, the axle 44 secures the wheel from rotating.

FIG. 6 is a diagram illustrating a top view of the end 38 of the fish tape 40 of FIG. 5 according to one embodiment of the present invention. As can be seen in FIG. 6, the wheel 42 may be disposed in a cutout portion 49 of the fish tape 40. The axle 44 may be attached to the fish tape 40 by any conventional method such as, for example, by fabricating ends 50 to be larger than the holes in the fish tape 40 in which the axle 44 is disposed. Legs 51 may be fabricated as an integral part of the fish tape 40 or may be attached to the fish tape 40.

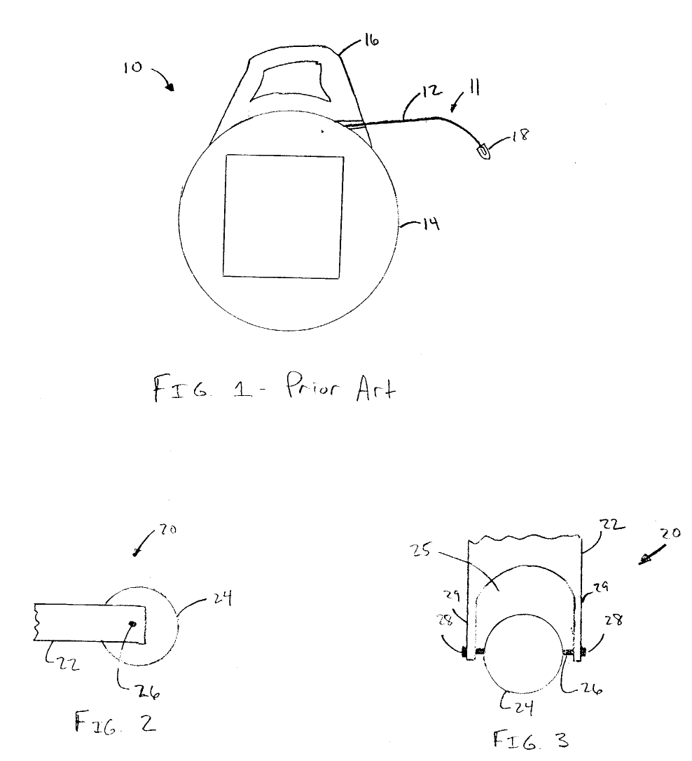

In operation, when the ends 20, 30, 38 are placed on a fish tape device, such as the fish tape device 10 of FIG. 1, the spherical portions 24, 36 and the wheel 42 allow the fish tapes 22, 32, 40, respectively, to more easily navigate spaces in which the fish tapes 22, 32, 40 are used. For example, when the fish tapes 22, 32, 40 are inserted into a conduit that has bends or elbows (e.g. a 90 degree elbow), the spherical portions 24, 36 and the wheel 42 allow the fish tapes 22, 32 40 to navigate such bends or angles.

In various embodiments, slots, grooves or holes may be formed or cut into the fish tapes 22, 32, 40 so that wire or cable may be tied to or looped through prior to retraction through the cavity or conduit in which the wire or cable is being pulled.

While several embodiments of the invention have been described, it should be apparent, however, that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention as defined by the appended claims.

What is claimed is:

1. A fish tape, comprising:
a spherical portion disposed in a cutout portion of an end of the fish tape, wherein the spherical portion is attached to the end of the fish tape.

2. The fish tape of claim 1, further comprising an axle attached to the end of the fish tape and extending through the spherical portion, wherein the axle is configured to enable the spherical portion to rotate.

3. The fish tape of claim 1, wherein the spherical portion is constructed of a material selected from the group consisting of steel, stainless steel and plastic.

4. The fish tape of claim 2, wherein the axle is constructed of a material selected from the group consisting of steel, stainless steel and plastic.

5. The fish tape of claim 1, wherein the spherical portion is fixedly attached to the end of the fish tape.

6. The fish tape of claim 1, wherein the spherical portion is rotatably attached to the end of the fish tape.

7. The fish tape of claim 1, wherein the fish tape is adapted to be used in a fish tape device having a reel assembly.

8. A fish tape, comprising:
a wheel disposed in a cutout portion of an end of the fish tape, wherein the wheel is attached to the end of the fish tape.

9. The fish tape of claim 8, further comprising an axle attached to the end of the fish tape and extending through the wheel, wherein the axle is configured to enable the wheel to rotate.

10. The fish tape of claim 8, wherein the wheel is constructed of a material selected from the group consisting of plastic, steel, and rubber.

11. The fish tape of claim 9, wherein the axle is constructed of a material selected from the group consisting of steel, stainless steel and plastic.

12. The fish tape of claim 8, wherein the wheel is fixedly attached to the end of the fish tape.

13. The fish tape of claim 8, wherein the wheel is rotatably attached to the end of the fish tape.

14. The fish tape of claim 8, wherein the fish tape is adapted to be used in a fish tape device having a reel assembly.

15. A fish tape, comprising:
a roller assembly attached to an end of the fish tape; and
a spherical portion disposed in the roller assembly.

16. The fish tape of claim 15, wherein the spherical portion is constructed of a material selected from the group consisting of stainless steel or rubber.

17. The fish tape of claim 15, wherein the spherical portion is fixedly attached to the roller assembly.

18. The fish tape of claim 15, wherein the spherical portion is rotatably disposed in the roller assembly.

19. The fish tape of claim 15, wherein the roller assembly is constructed from a material selected from the group consisting of plastic and steel.

20. The fish tape of claim 15, wherein the fish tape is adapted to be used in a fish tape device having a reel assembly.
